(19) United States
(12) Patent Application Publication
(10) Pub. No.: US 2026/0002639 A1
(43) Pub. Date: Jan. 1, 2026

(54) LINER FOR HYDROGEN CONTAINMENT

(71) Applicant: EnerVenue Holdings, Ltd., Fremont, CA (US)

(72) Inventors: Nelson Dichter, Oakland, CA (US); Kenneth Kirkland, San Francisco, CA (US); Jason Trafas, Fremont, CA (US); Stephen Rivest, Cupertino, CA (US); Majid Keshavarz, Pleasanton, CA (US)

(21) Appl. No.: 19/247,427

(22) Filed: Jun. 24, 2025

Related U.S. Application Data
(60) Provisional application No. 63/664,346, filed on Jun. 26, 2024.

(51) Int. Cl. F17C 1/16; B32B 1/08; B32B 7/12; B32B 27/08; B32B 27/18; B32B 27/30; B32B 27/32; B32B 27/34

(52) U.S. Cl. CPC F17C 1/16; B32B 1/08; B32B 7/12; B32B 27/08; B32B 27/18; B32B 27/306; B32B 27/32; B32B 27/34; B32B 2250/24; B32B 2439/40; B32B 2457/10; B32B 2597/00; F17C 2201/0109; F17C 2203/0604; F17C 2203/0624; F17C 2203/066; F17C 2203/0673; F17C 2209/2163; F17C 2209/221; F17C 2209/232; F17C 2221/012

(57) ABSTRACT

A liner that can be used in a pressure vessel is presented in accordance with some embodiments, the liner includes a first layer of polymer material; a second layer of polymer material; and a layer of Ethylene Vinyl Alcohol (EVOH) between the first layer and the second layer. In some embodiments, the first layer and the second layer can each be one of high-density polyethylene (HDPE), polyamide (PA), polypropylene (PP), or Polyamide (PA6). A method of forming a pressure vessel according to some embodiments of the present disclosure includes forming a liner having a first layer of polymer material, a second layer of polymer material, and a layer of Ethylene Vinyl Alcohol (EVOH) between the first layer and the second layer; and welding caps to the liner.

### RELATED APPLICATIONS

This application claims priority to U.S. Provisional Patent Application No. 63/664,346 filed Jun. 26, 2024, which is incorporated by reference herein in its entirety.

### TECHNICAL FIELD

Embodiments of the present invention are related to hydrogen storage and hydrogen transport and, in particular, to a composite liner with a liner material appropriate for hydrogen storage and hydrogen transport.

### DISCUSSION OF RELATED ART

Hydrogen containment is an important aspect of the broader hydrogen technology.

Hydrogen is a component to many technologies, including fuel cells and battery technologies. Hydrogen can be stored as a compressed gas or cryogenic fluid and may be combined with other gasses for efficient storage and transport.

In one particular application, hydrogen is a component of metal-hydrogen batteries for grid-scale energy storage. Such systems are invaluable for the progression of renewable energy resources such as wind or solar to become competitive. Additionally, many manufacturers are looking towards a hydrogen highway that allows for hydrogen powered automobiles (e.g., fuel cells). The hydrogen highway is dependent on efficient production, storage, and transport of hydrogen.

However, in all of these systems, hydrogen leakage from currently available storage systems is a problem. In particular, in the case of metal-hydrogen batteries the containment of hydrogen within the battery over a long period of time is important for the longevity of the battery. In some estimates, at least 90% of the hydrogen should be contained within the pressure vessel of the battery over a period of 20 years or more in order to insure the longevity of those battery systems without having to service and recharge the batteries. In the case of storage or transport of hydrogen gas, leakage of hydrogen from the storage tanks becomes an ongoing issue.

Consequently, there is a need for better hydrogen containment for various applications.

### SUMMARY

According to some embodiments, a liner that can be used in a pressure vessel is presented In accordance with some embodiments, the liner includes a first layer of polymer material; a second layer of polymer material; and a layer of Ethylene Vinyl Alcohol (EVOH) between the first layer and the second layer. In some embodiments, the first layer can be one of high-density polyethylene (HDPE), polyamide (PA), polypropylene (PP), or Polyamide (PA6). In some embodiments, the second layer can be one of high-density polyethylene (HDPE), polyamide (PA), polypropylene (PP), or Polyamide (PA6). In some embodiments, additional layers may be positioned between the first layer and the second layer. In some embodiments, a first adhesive layer can be included between the first layer and the layer of EVOH a second adhesive layer can be included between the layer of EVOH and the second layer.

In some embodiments, the first layer is high-density polyethylene (HDPE) and the second layer is HDPE. In some embodiments, the first layer is high-density polyethylene (HDPE) and the second layer is polyamide (PA6). In some embodiments, the first layer is polypropylene (PP) and the second layer is polyamide (PA6).

In some embodiments, laser light is transmitted through the liner to facilitate welding of the liner to a component in contact with the liner. In some embodiments, the laser light is in the near infra-red (NIR) range.

In some embodiments, the liner is formed to be a hydrogen storage vessel. In some embodiments, the liner is formed to be a pressure vessel for a metal-hydrogen battery. In some embodiments, the liner is formed to be a pipeline. In some embodiments, the liner further includes a composite wrapping. In some embodiments, the composite wrapping is formed of a fiber reinforcement and resin.

In some embodiments, a method of forming a pressure vessel is also presented. A method of forming a pressure vessel according to some embodiments of the present disclosure includes forming a liner having a first layer of polymer material, a second layer of polymer material, and a layer of Ethylene Vinyl Alcohol (EVOH) between the first layer and the second layer; and welding caps to the liner. In some embodiments, forming the liner includes extruding the first layer, the second layer, and the layer of EVOH. In some embodiments, the first layer is one of high-density polyethylene (HDPE), polyamide (PA), polypropylene (PP), or Polyamide (PA6). In some embodiments, the second layer is one of high-density polyethylene (HDPE), polyamide (PA), polypropylene (PP), or Polyamide (PA6). In some embodiments, the method further includes applying additional layers positioned between the first layer and the second layer. In some embodiments, the method further includes applying a first adhesive layer between the first layer and the layer of EVOH and applying second adhesive layer between the layer of EVOH and the second layer.

In some embodiments, the method further includes laser welding with laser light is transmitted through the liner to facilitate welding of the liner to a component in contact with the liner. In some embodiments, the laser light is in the near infra-red (NIR) range.

In some embodiments, forming the liner includes forming the liner to be a hydrogen storage vessel. In some embodiments, forming the liner includes forming the liner to be a pressure vessel for a metal-hydrogen battery. In some embodiments, forming the liner includes forming the liner to be a pipeline.

In some embodiments, the method further includes wrapping the liner with a composite material. In some embodiments, the composite material includes fiber reinforcement and resin. These and other embodiments are discussed below with respect to the following figures.

### BRIEF DESCRIPTION OF THE FIGURES

FIGS. 1A and 1B illustrate diffusion of a gas through a material.

FIGS. 2A, 2B, 2C, and 2D illustrate liners according to some embodiments of the present disclosure.

FIGS. 3A and 3B illustrate examples of liner material according to some embodiments of the present disclosure.

FIGS. 4A and 4B illustrates an extruder and feeding a crosshead to produce a liner as illustrated in FIGS. 2A through 2D.

FIGS. 5A and 5B illustrate a testing apparatus to test samples of liner material as illustrated in FIGS. 3A and 3B.

FIGS. 6A and 6B illustrate some test results for components of liners and liners according to some embodiments of the present disclosure.

FIG. 7 illustrates the optical absorbance of liner materials according to some embodiments of the present disclosure.

FIGS. 8A and 8B illustrate laser welding of a liner material according to some embodiments of the present disclosure.

FIGS. 9A and 9B illustrate example pressure vessels using the liner according to some embodiments of the present disclosure.

FIGS. 10A and 10B illustrate an example of wrapping the pressure vessel illustrated in FIGS. 9A and 9B with a composite material.

FIG. 11 illustrates a method of forming a pressure vessel according to some embodiments of the present disclosure.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Embodiments of the present disclosure provide for a liner that substantially reduces the leakage of hydrogen from a vessel. In some applications, the vessel can be a pipeline or a storage container. In some applications, the vessel can be a pressure vessel that houses a metal-hydrogen battery. Examples of a metal hydrogen battery that can utilize a liner according to some embodiments are described in more detail in U.S. patent application Ser. No. 17/830,193, entitled “Electrode Stack Assembly for a Metal Hydrogen Battery,” filed on Jun. 1, 2022, which is herein incorporated by reference. Another embodiment of electrode stack 101 is described in U.S. patent application Ser. No. 17/687,527, entitled “Electrode Stack Assembly for a Metal Hydrogen Battery,” filed on Mar. 4, 2022, which is also incorporated by reference in its entirety. Other examples of a metal-hydrogen battery that can use a liner according to the present disclosure is disclosed in U.S. Prov. Application 63/658,165 entitled “Nickel-Hydrogen Battery Configurations for Grid-Scale Energy Storage,” filed on Jun. 10, 2024, which is also herein incorporated by reference in its entirety.

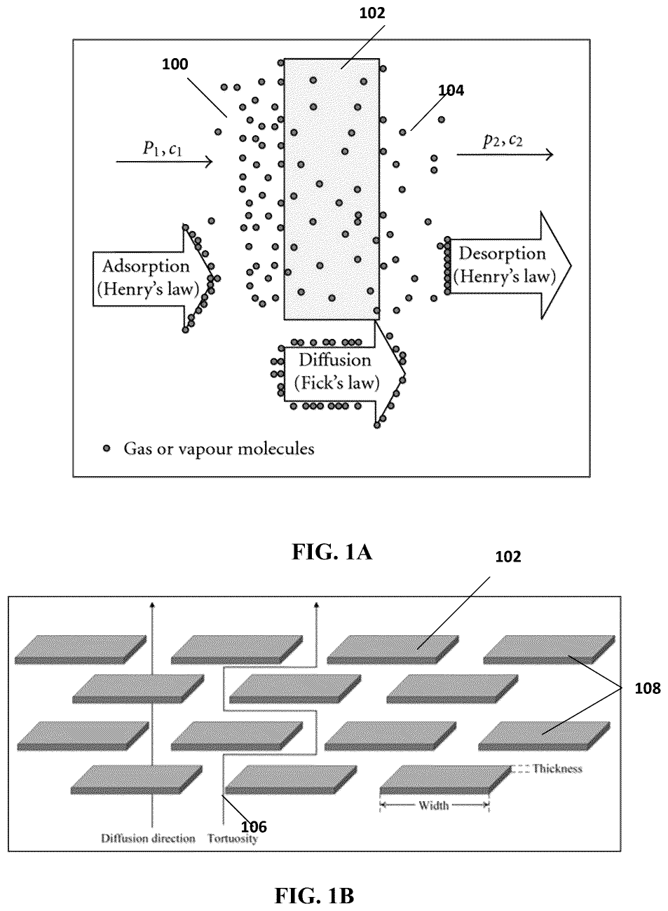

FIGS. 1A and 1B illustrate a simplified model for diffusion of a gas 100 through a material 102, which may be a polymer material. As shown in FIG. 1A, gas 100 has a pressure and concentration (P1, c1) while the concentration on the opposite side of a material 102 is given by P2, c2). Diffusion can be the result of absorption of the gas into material 102, diffusion of the gas through material 102, and desorption of the gas from material 102 into gas 104. In particular, where P1 is greater than P2 and c1 is greater than c2, then absorption of gas into material 102 can be described by Henry's Law, which indicates that the amount of gas absorbed into material 102 is proportional to the pressure of that case, P1. Henry's law can also describe the desorption of gas from material 102 to provide for the gas 104. Diffusion of gas through material 102 can be described by Fick's Law, which states that the overall diffusion through material 102 is proportional to the concentration gradient across the material 104. The proportionality constant is referred to as the diffusion constant. A permeability constant can be used to describe the diffusion process in material 102 and depends on the diffusion constant, the thickness of material 102, and other materially dependent parameters.

FIG. 1B further illustrates the diffusion mechanism through material 102. As illustrated, diffusion often takes the tortuous path 106 using the interstitial spaces between components 108 of material 102.

As has been discussed above, in a pressure vessel for a battery there is a need to contain 90% of the hydrogen gas for over 20 years to provide for batteries with good lifetime without a need for a hydrogen recharge. Further, standard high density polyethylene tubing has too high a permeation coefficient to meet this requirement. Consequently, often heavier and more expensive materials (e.g. sufficiently thick-walled stainless-steel vessels) can be used, but lighter weight and less expensive materials are desirable. Further, the materials used must be weldable so that fittings and end caps can be used to create pressure vessels, storage vessels, or pipeline components.

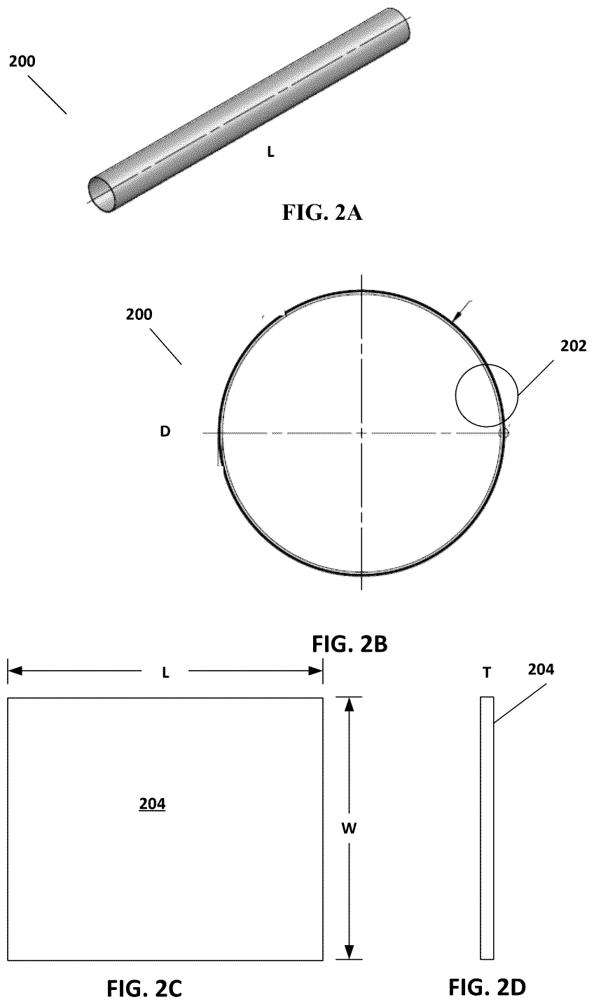

In many applications, a liner according to some embodiments of the present disclosure can be formed as a tubular structure 200 as is illustrated in FIGS. 2A, 2B, and 2C. FIGS. 2A and 2B illustrates a tubular liner 200 formed from liner material according to embodiments of the present disclosure. As shown in FIG. 2A, tubular liner 200 has a length L and an inner diameter D. Length L and diameter D can be any required length and diameter. Consequently, tubular liner 200 can be used for storage, can be used in a pipeline, and can be used in a pressure vessel for a metal-hydrogen battery. As illustrated in FIGS. 2C and 2D, a liner can be produced as a sheet liner 204 with length L, width W, and thickness T. Sheet liner 204 can be cut and formed into other shapes to form an enclosed vessel to contain hydrogen.

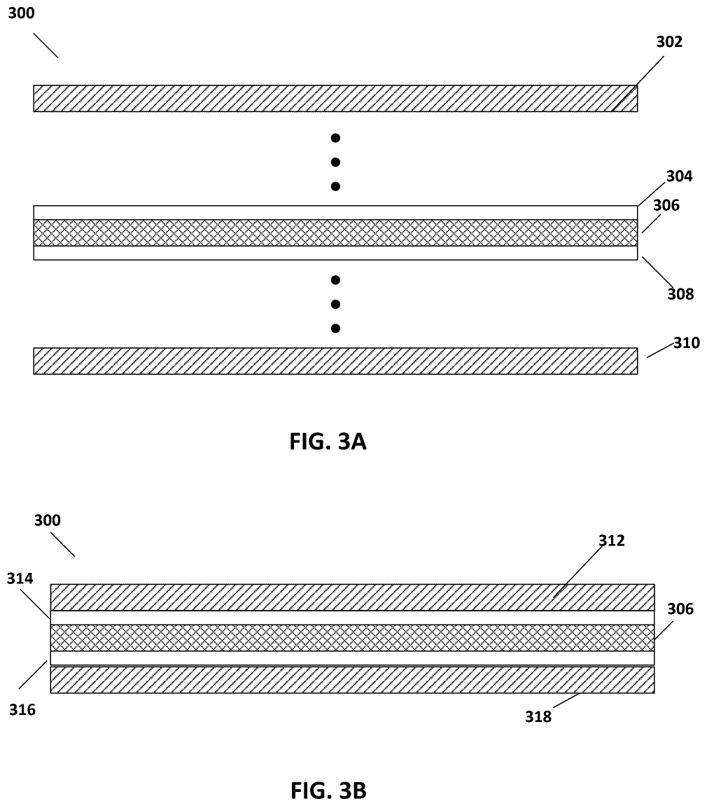

FIG. 3A illustrates a liner material 300 that can be used in tubular liner 200 or sheet liner 204 according to some embodiments of the present disclosure. As discussed above, whether liner material 300 is formed into a tube liner 200 or a sheet liner 204 as discussed above, liner material 300 has the function of being as impervious to hydrogen transmission as possible. In some embodiments, liner material 300 can have a hydrogen permeation coefficient sufficient to contain a specified percentage of hydrogen within a pressure vessel over a specified period of time. This characteristic can be achieved using a composite material having at least one layer of Ethylene Vinyl Alcohol (EVOH) as is discussed further below.

FIG. 3A illustrates a liner material 300 according to some embodiments of the present disclosure. As illustrated in FIG. 3A, liner material 300 includes a plurality of layers starting with layer 302 and ending with layer 310. Layers 302 and 310 can be any polymer layers that have good chemical resistivity and, in some applications, that can be laser welded to other components. For example, layers 302 and 310 can be formed from high-density polyethylene (HDPE), polyamide (PA), polypropylene (PP), or other such components. Layer 306 is an EVOH layer that provides a barrier to gas, including hydrogen. The material layers 300 can be adhered to one another using adhesive, or tie layers, that can be formed from different grades of polyethylene, for example HDPE. Adhesive layers 304 and 308, therefore, are illustrated on EVOH layer 306. In some embodiments, material layers 300 can be extruded with special function groups or additives that enable direct bonding between material layers 300, excluding the need for tie layers 304 and 308.

Although liner material 300 can be formed of any number of layers 302 and 310, each having any thickness, and may include any number of EVOH layers 306, FIG. 3B illustrates a particular example of liner material 300 having a five-layer structure. As illustrated in FIG. 3B, liner material 300 includes EVOH layer 306 that is sandwiched between layers 312 and 318. Layers 312 and EVOH layer 306 are adhered to one another with a tie layer, or adhesive layer, 314. Layers 306 and 318 are adhered to one another with a tie layer, or adhesive layer, 316. As discussed above, tie layers 314 and 316 can be different grades of polyethylene.

In the 5-layer liner material 300 as illustrated in FIG. 3B, each of layers 312 and 318 can be formed of high-density polyethylene (HDPE), polypropylene (PP), or Polyamide (Nylon 6 or polycaprolactam—PA6). For example, area 202 in tubular liner 200 can be formed of liner material 300 that are layered from inside of tubular liner 200 to outside of tubular liner as (layer 312/tie layer 314/EVOH layer 306/tie layer 316/layer 318). This can, for example, be (HDPE/Adhesive/EVOH/Adhesive/HDPE); (PP/Adhesive/EVOH/Adhesive/PA6); or (HDPE/Adhesive/EVOH/Adhesive/PA6). In any case, as is discussed below, liner material 300 can be transparent to laser light that can be used to laser weld layer 312 to an underlying structure, e.g. a cap structure or another structure.

As described above, EVOH layer 306 is a very good barrier to hydrogen, but is not very chemically resistant and is not amenable to laser welding. Consequently, layers 312 and 318 can be formed to provide the chemical resistance and to allow for laser welding. In some embodiments, where laser material 300 is used in tubular liner 200, the inner layer 312 can be a thicker piece for increased protection of EVOH layer 306 from the contents contained within tubular liner 200 (e.g., an electrolyte in the case of a battery structure) and to allow for excess material to facilitate laser welding. Similar to inner layer 312, outer layer 318 offers protection of the EVOH layer 306 to environmental elements.

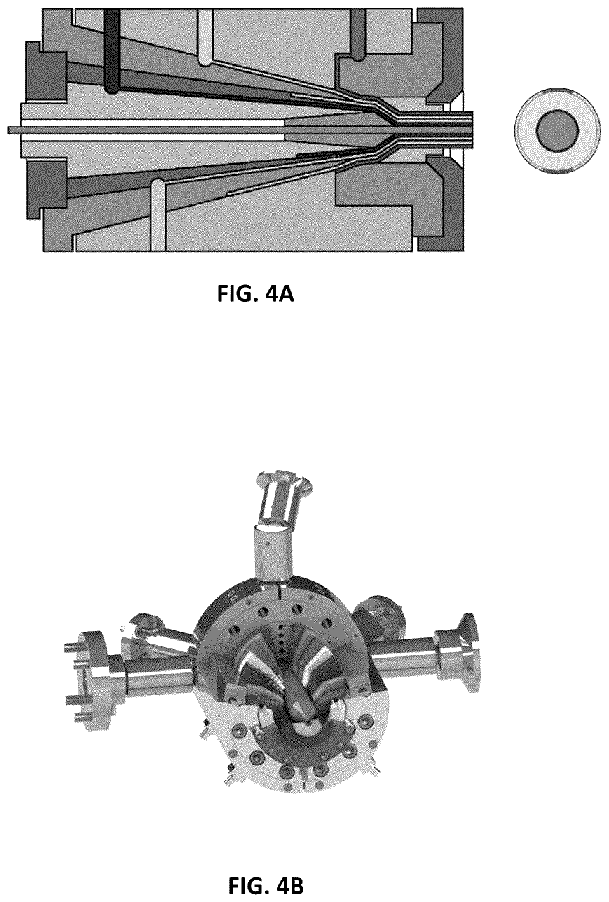

Tube liner 200 or sheet liner 204 can be formed with multi-layer liner material 300 through an extrusion and crosshead process. In some examples, FIGS. 4A and 4B illustrate a three-layer extruder shown in FIG. 4A feeding a crosshead shown in FIG. 4B that produces tube liner 200 with multi-layer liner material 300 as illustrated in FIG. 3B.

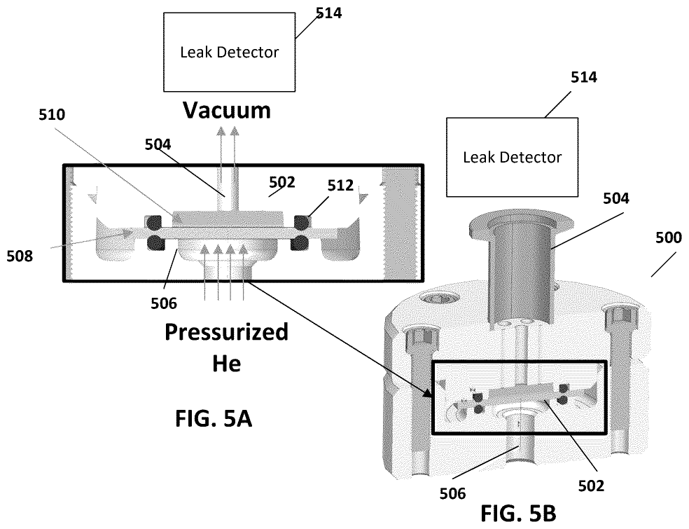

FIGS. 5A and 5B illustrate a testing chamber 500 to determine the permeation coefficient of multilayer liner materials 300 according to some embodiments of the present disclosure. In testing chamber 500, a sample disc 508 of liner material 300 can be produced, for example by extrusion of a sheet liner 204. Sample disc 508 is held in a chuck 502. Chuck 502 includes a clamp 512 that holds sample disc 508. As is further illustrated, pressurized helium is applied to one side of sample disk 508 through a source pipe 506 and a porous stainless steel retainment plate 510 pumped with vacuum through a vacuum pipe 504 is applied to sample disk 508 opposite source pipe 506. A helium leak detector 514 is attached to vacuum pipe 504 to measure He that diffuses through sample disk 508 and porous stainless steel retainment plate 510. In some cases, the test can be conducted with hydrogen using a hydrogen leak detector.

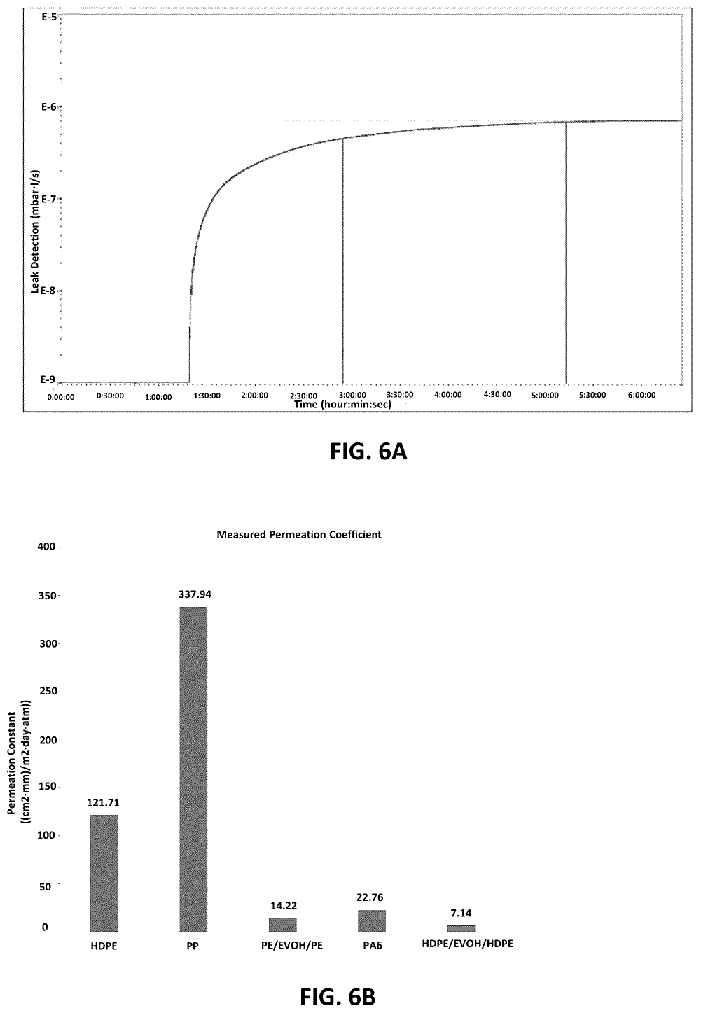

FIG. 6A illustrates measurements by a leak detector 514 measuring through sample disk 508 as illustrated in FIG. 5B. Leak detection is measured in mbar l/s and the scale is 1.000E-9 to 1.000E-5 mbar·l/s. The graph is over a time of about 5.5 hrs. In some embodiments, source pipe 506 can supply pressurized helium at 500 psi. Leak detector 514 measures in vacuum pipe 504. The permeation coefficient can be determined from the leak-rate data provided in graphs such as the leak detection graph shown in FIG. 6A.

FIG. 6B illustrates the permeation coefficient determined from leak detection measurements for various embodiments and layers of liner material 300 as discussed above. As discussed above, the results presented in FIG. 6B is determined using industrial grade helium at source pipe 506 at pressure of 500 psi. In this data, the exposed area of sample disk 508 (i.e. the area exposed to helium) is 709.22 mm².

As is illustrated in FIG. 6B, HDPE itself provides a permeation coefficient of 121.71 (cm²·mm)/(m²·day atm). Polypropylene (PP) provides a permeation coefficient of 337.94 (cm²·mm)/(m²·day atm). A multilayer liner material 300 with PE/EVOH/PE where the EVOH is 300 μm and PE is polyethylene is 14.22 (cm²·mm)/(m²·day atm). PA6 provides for a permeation coefficient of 22.76 (cm²·mm)/(m²·day atm). However, a liner material provided of HDPE/EVOH/HDPE provides a permeation coefficient of 7.14 (cm²·mm)/(m²·day atm). Each of the layers indicated in FIG. 6B, as illustrated in FIG. 3B, is separated by an adhesive layer as discussed above.

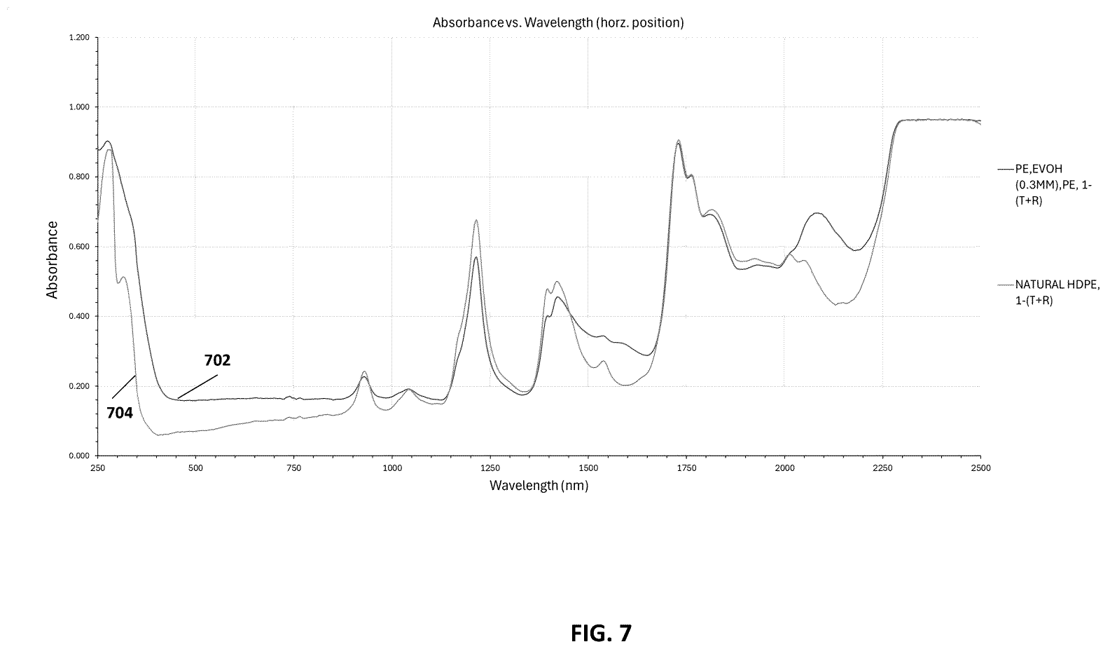

As is illustrated in FIG. 6B, linear material 300 that is formed of HDPE/EVOH/HDPE provides a good permeation coefficient, it is also desired that linear material 300 be sufficiently optically transparent to provide for laser welding through linear material 300. FIG. 7 illustrates the absorbance of aspects of liner material 300 as a function of wavelength in nm. In particular, curve 702 illustrates absorption of liner material composed of PE/EVOH/PE, where the thickness of EVOH is 0.3 mm. Absorption curve 704 illustrates absorption of HDPE. In curves 702 and 704, the polymers are left natural (i.e. uncolored).

As illustrated in FIG. 7, absorbance is measured in the near infrared (NIR) region (roughly 800 nm to 2500 nm) for a multilayer sample (curve 702) and for HDPE (curve 704). Absorbance is generally measured by measuring the light that passes through the same (the transmittance), the light that is reflected from the sample (the reflectance) and calculating the absorbance as 1−(transmittance+reflectance). As such, a value of 1.000 would represent 100% absorbance and a value of 0.000 would represent 0% absorbance.

A common wavelength that can be used for laser welding is around 1 μm (1000 nm). As shown in FIG. 7, there is no significant difference in absorbance around the 1 μm region, which appears to have about a 20% absorbance. However, wavelengths anywhere in the NIR region can be used.

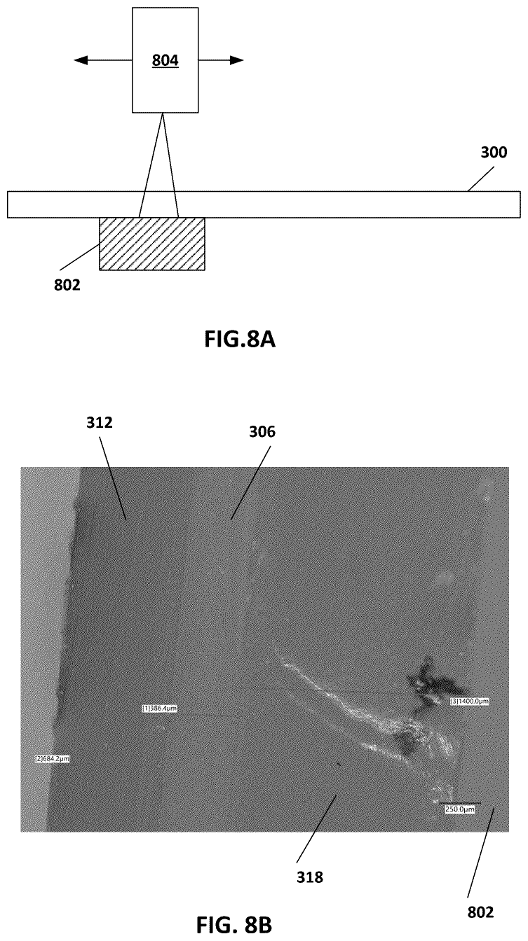

FIG. 8A illustrates laser welding through liner material 300. As illustrated in FIG. 8A, liner material 300 is placed in contact with material 802, to which it is to be laser welded. A laser 804 is positioned to apply laser light 804 onto liner material 300. Because of the low absorbance of liner material 300, a substantial amount of the energy from laser light 804 is then incident on material 802. In some applications, material 802 can be HDPE that has been colored, for example with charcoal black or other coloration, to better absorb light from laser 804.

As was discussed above, laser 804 may produce light with sufficient power and at a particular wavelength to weld material 802 to liner material 300. As is further illustrated, laser 804 may be moved relative to liner material 300 and material 302 so that all parts can be welded to liner material 300. In some cases, laser 804 may move but in some other applications the combination of laser material 300 and material 802 can be moved relative to laser 804. As discussed above, light from laser 804 can be in the NIR wavelength region, for example at around 1 μm (e.g. 970 nm, 1064 nm, and 2 μm light can be used).

FIG. 8B illustrates a cross section of a liner material 300 after welding to material 802. In this example, liner material 300 is HDPE/EVOH/HDPE in character. Consequently, the outside layer, HDPE layer 312 has a thickness 684.2 μm of HDPE, EVOH layer 306 is 386.4 μm, and HDPE layer 318 is 1400.0 μm. As is illustrated, damage due to welding can be observed on the interface between material 802 and HDPE layer 318. However, EVOH layer 306 remains intact and undamaged after welding. In some cases, this damage can be substantially reduced, if not eliminated, by proper tuning of laser 804.

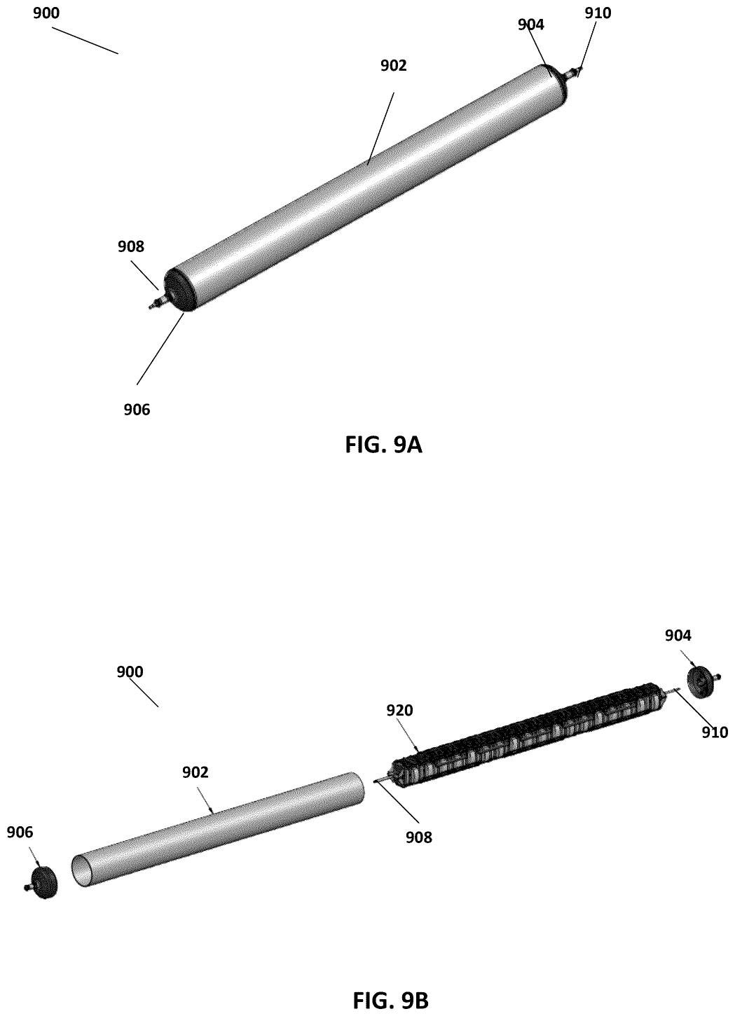

FIGS. 9A and 9B illustrate examples of pressure vessels 900 that are constructed using tube liner 200 formed of liner material 300 as discussed above. As discussed above, tube liner 200 formed of liner material 300 can be used to form storage vessels, pipelines, or other pressure vessels. FIG. 9A illustrates a pressure vessel 900 that includes liner 902 welded to end caps 904 and 906. As discussed above, end caps 904 and 906 can be formed of HDPE to facilitate the laser welding. End caps 904 and 906 may include access components 910 and 908, respectively, which may be valves, electrodes, or other components. In some cases, one of the end caps may be sealed in order to form a sealed end of pressure vessel 900.

In some embodiments, pressure vessel 900 may also include internal components that can be welded to liner 902. FIG. 9B illustrates an example where internal components 920, which may be a battery stack, is included. As illustrated in FIG. 9B, internal components can be inserted into liner 902 and end caps attached over internal components prior to welding. In some embodiments, pressure vessel 900, whether used as a storage vessel, a pressure vessel, or a pipeline, can be wrapped with a structural material, e.g. fiber reinforced polymer.

A Composite Overwrapped Pressure Vessel (COPV) is the primary structural and protective shell that contains and protects liner 200 of pressure vessel 900, which may house nickel-hydrogen battery internal components 920 within. A Type III COPV is defined as a thin metal liner overwrapped with a composite laminate for structural reinforcement. A Type IV COPV is defined as a plastic liner overwrapped with a composite laminate for structural reinforcement. The primary purpose of the COPV is to resist the internal mechanical pressure loads of the cycling battery or other components of the resulting pressure vessel 900. The COPV alone may not be considered airtight and is therefore used in combination with the impermeable liner 200 which provides a fluid retaining barrier for the fluids within the pressure vessel 900. Although most plastic materials that can be used to form liner 200 in a Type IV COPV, such as HDPE or polypropylene, have hydrogen permeation rates that are several orders of magnitude higher than similarly designed metal pressure vessels, such as stainless steel, the permeation resistance can be significantly increased by using a multi-layer extrusion which includes carefully selected permeation resistant materials, such as EVOH. Constructing the liner in this manner can mitigate this drawback of Type IV COPVs for use in the containment of hydrogen.

COPVs have been developed for high pressure gas storage and have been in service since the 1970's. They are often manufactured by the filament winding process where high tensile strength reinforcement fibers, for example fiberglass, carbon fiber, aramids, Ultra High Molecular Weight Polyethylene (UHMWPE) or other such materials, are coated with resin (epoxy, vinyl ester, polyester, or UV cured resins) and directly laid in a specific pattern onto a cylindrical liner. The continuous fibers provide tensile strength and stiffness and carry the primary loads. The resin carries shear loads, transfers loads between fibers, and maintains fiber position.

The filament winding process is controlled by several parameters which regulate bandwidth of the fiber tape, fiber wet out, constant and/or variable fiber tension, winding speed, acceleration/deacceleration, dwell, and internal pressure of the liner during winding.

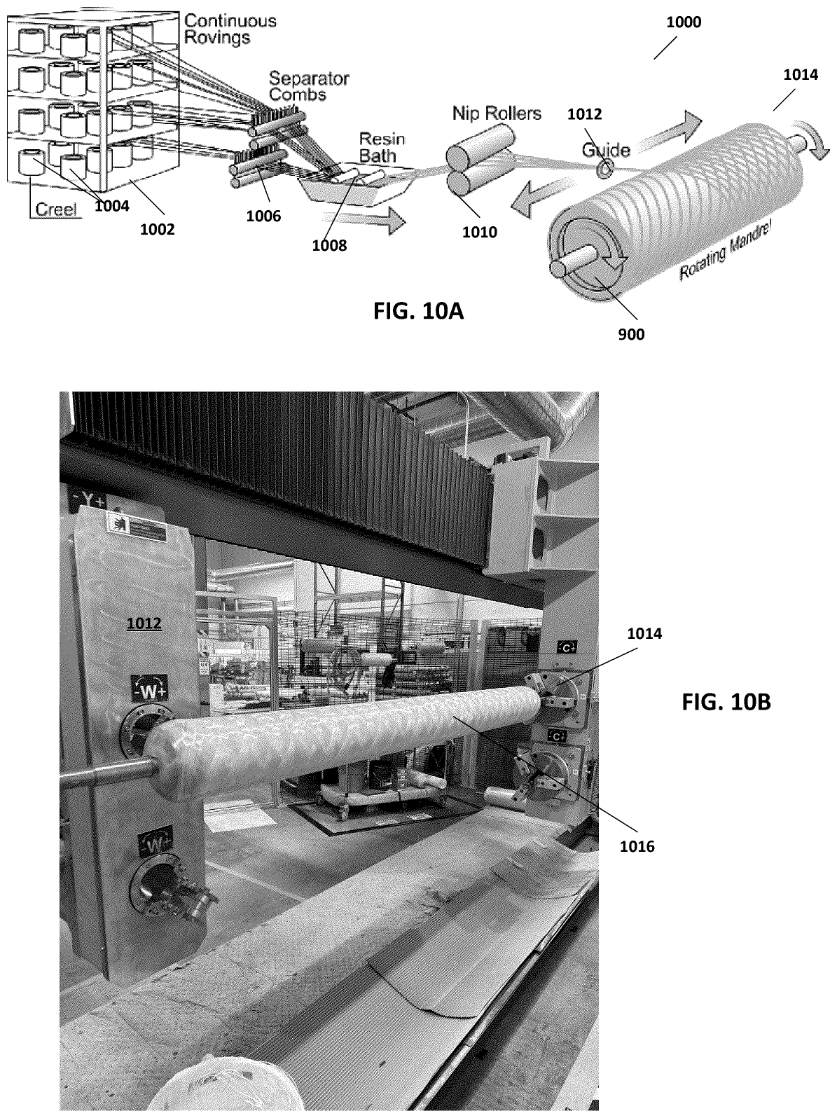

FIGS. 10A and 10B illustrate a winding system 1000 for wrapping pressure vessel 900 according to some embodiments of the present disclosure. As indicated in FIG. 10A, winding system 1000 includes a creel 1002, separator combs 1006, a resin bath 1008, rollers 1010, a guide 102, and a rotating mandrel 1014. As illustrated in FIG. 10A, pressure vessel 900 is mounted on rotating mandrel 1014.

Creel 1002 is a rack to house raw, dry, continuous fiber roving spools 1004. As is shown, fiber from spools 1004 through separator combs 1006. Separator combs 1006 separate, guide and align the fiber rovings from spools 1004 in creel 1002. The fiber rovings are then feed into resign bath 1008, where the fiber rovings are wetted with a resin. From resin bath 1008, the fiber rovings pass through rollers 1010, which support, guide, assist in wet out, and provide tension to the fiber rovings. The rovings are then fed through a guide 1012, which can be a winding eye, which guides the grouping of wet rovings (the bandwidth) onto pressure vessel 900 which is mounted on mandrel 1014 and rotating. Guide 1012 can be programmed to guide the rovings onto rotating pressure vessel 900 in various patterns.

FIG. 10B illustrates a wound pressure vessel 1016, which is pressure vessel 900 that has been wrapped in winding system 1000 as described above. FIG. 10B, for example, illustrates an example of guide 1012 and rotating mandrel 1014 with pressure vessel 900 mounted into mandrel 1014.

Pressure vessel theory for isotropic materials (usually metals) calculates burst pressure and Factor of Safety (FOS) with a few basic parameters: internal pressure, outside diameter, wall thickness, and maximum allowable material stress. For composite overwrapped vessels, however, the winding pattern for the fiber is engineered to resist pressure and stress and strain forces. The winding pattern is based on the pressure vessel theory above, but is also based on a number of other parameters. Those parameters include the angles of the fiber (89 deg. to 9 deg.), the bandwidth thickness (i.e. the thickness of the group of wet rovings presented to guide 1012), the fiber volume fraction (FvF) of laminate, the number of helical layers, the helical layer thickness, the number of hoop layers, and the radial or hoop layer thickness. In some embodiments, for example, roughly an equal number of Hoop and Helical layers having 3 to 5 different angles can be used to meet structural requirements.

After the filament winding pattern is completed with the resin in the uncured state, the COPV's are then subjected to a cure cycle profile to cure or harden the resin. Thermally cured resins are placed in an oven following a parameterized recipe of time, temperature, ramp and dwell. For UV cured resins the cure cycle profile is parameterized by time, irradiance dosage, lamp distance from composite, and rotational speed. In some embodiments, a UV curing resin can be used, in which case the curing process involves exposure of the COPV to UV. This process offers several advantages for our manufacturing process and ultimately the product itself.

The laminate or “layup” (resin and fiber reinforcement) that is applied as shown in FIGS. 10A and 10B to form wound pressure vessel 1016 is configured to contain the pressure and fail at a prescribed limit of, for example, five (5) times the maximum allowable pressure (MAWP). Further, it may be limited to limit the vessel elongation under cycling and to protect against and resist other types of mechanical stress and damage such as impact, drop, thermal loading, fire resistance, environmental/hygothermal loads, transportation loads and static loads such as bending.

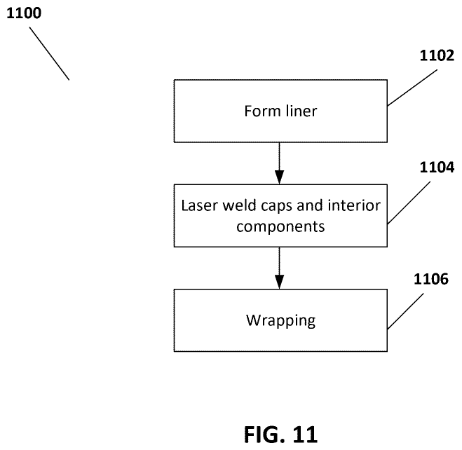

FIG. 11 illustrates a method 1100 of forming a pressure vessel according to some embodiments of the present disclosure. As shown in FIG. 11, the method begins in step 1102 with forming a liner 200, as discussed above with respect to FIGS. 2A through 4B. In step 1104, caps and internal components are laser welded to the liner as is described, for example, in FIGS. 8A and 8B, to form a pressure vessel 900 as is illustrated in FIGS. 9A and 9B. Finally, in step 1106, the pressure vessel 900 is wrapped with a composite material as is discussed above with respect to FIGS. 10A and 10B.

The above detailed description is provided to illustrate specific embodiments of the present invention and is not intended to be limiting. Numerous variations and modifications within the scope of the present invention are possible. The present invention is set forth in the following claims.

What is claimed is:

1. A liner, comprising:
a first layer of polymer material;
a second layer of polymer material; and
a layer of Ethylene Vinyl Alcohol (EVOH) between the first layer and the second layer.

2. The liner of claim 1, wherein the first layer is one of high-density polyethylene (HDPE), polyamide (PA), polypropylene (PP), or Polyamide (PA6).

3. The liner of claim 1, wherein the second layer is one of high-density polyethylene (HDPE), polyamide (PA), polypropylene (PP), or Polyamide (PA6).

4. The liner of claim 1, further including additional layers positioned between the first layer and the second layer.

5. The liner of claim 1, further including a first adhesive layer between the first layer and the layer of EVOH a second adhesive layer between the layer of EVOH and the second layer.

6. The liner of claim 1, wherein the first layer is high-density polyethylene (HDPE) and the second layer is HDPE.

7. The liner of claim 1, wherein the first layer is high-density polyethylene (HDPE) and the second layer is polyamide (PA6).

8. The liner of claim 1, wherein the first layer is polypropylene (PP) and the second layer is polyamide (PA6).

9. The liner of claim 1, wherein laser light is transmitted through the liner to facilitate welding of the liner to a component in contact with the liner.

10. The liner of claim 9, wherein the laser light is in the near infra-red (NIR) range.

11. The liner of claim 1, formed to be a hydrogen storage vessel.

12. The liner of claim 1, formed to be a pressure vessel for a metal-hydrogen battery.

13. The liner of claim 1, formed to be a pipeline.

14. The liner of claim 1, further including a composite wrapping.

15. The liner of claim 1, wherein the composite wrapping is formed of a fiber reinforcement and resin.

16. A method of forming a pressure vessel, comprising:
forming a liner having a first layer of polymer material, a second layer of polymer material, and a layer of Ethylene Vinyl Alcohol (EVOH) between the first layer and the second layer; and
welding caps to the liner.

17. The method of claim 16, wherein forming the liner includes extruding the first layer, the second layer, and the layer of EVOH.

18. The method of claim 16, wherein the first layer is one of high-density polyethylene (HDPE), polyamide (PA), polypropylene (PP), or Polyamide (PA6).

19. The method of claim 16, wherein the second layer is one of high-density polyethylene (HDPE), polyamide (PA), polypropylene (PP), or Polyamide (PA6).

20. The method of claim 16, further including additional layers positioned between the first layer and the second layer.

21. The method of claim 16, further including applying a first adhesive layer between the first layer and the layer of EVOH and applying second adhesive layer between the layer of EVOH and the second layer.

22. The method of claim 16, wherein the first layer is high-density polyethylene (HDPE) and the second layer is HDPE.

23. The method of claim 16, wherein the first layer is high-density polyethylene (HDPE) and the second layer is polyamide (PA6).

24. The method of claim 16, wherein the first layer is polypropylene (PP) and the second layer is polyamide (PA6).

25. The method of claim 16, further including laser welding with laser light is transmitted through the liner to facilitate welding of the liner to a component in contact with the liner.

26. The method of claim 24, wherein the laser light is in the near infra-red (NIR) range.

27. The method of claim 16, wherein forming the liner includes forming the liner to be a hydrogen storage vessel.

28. The method of claim 16, wherein forming the liner includes forming the liner to be a pressure vessel for a metal-hydrogen battery.

29. The method of claim 16, wherein forming the liner includes forming the liner to be a pipeline.

30. The method of claim 16, further including wrapping the liner with a composite material.

31. The method of claim 29, wherein the composite material includes fiber reinforcement and resin.
